(19) United States
(12) Patent Application Publication
(10) Pub. No.: US 2022/0091366 A1
(43) Pub. Date: Mar. 24, 2022

(54) STEMMED OPTICAL MIRRORS FOR LOW MOUNTING INDUCED DISTORTION DUE TO MECHANICAL STRESS

(71) Applicant: Edmund Optics, Inc., Barrington, NJ (US)

(72) Inventors: Lars Sandström, Philadelphia, PA (US); Shawn Scarfo, Pittsgrove, NJ (US); Dale Josephson, Edgewood, NM (US); Andrew Fisher, King of Prussia, PA (US)

(73) Assignee: Edmund Optics, Inc., Barrington, NJ (US)

(21) Appl. No.: 17/478,341

(22) Filed: Sep. 17, 2021

Related U.S. Application Data
(60) Provisional application No. 63/080,154, filed on Sep. 18, 2020.

(51) Int. Cl. G02B 7/192; G02B 5/10

(52) U.S. Cl. CPC G02B 7/192; G02B 26/06; G02B 5/10

(57) ABSTRACT

A mirror includes an optical portion including an optical surface opposite to a rear surface of the optical portion; and a mounting stem protruding from the rear surface of the optical portion and configured to mount to an optical mount.

### CROSS REFERENCE TO RELATED APPLICATIONS

This application claims the benefit of U.S. Provisional Patent Application No. 63/080,154, filed Sep. 18, 2020, which is hereby incorporated by reference in its entirety for all purposes as if fully set forth herein.

### TECHNICAL FIELD

The disclosure relates generally to optical systems, and more particularly, mirrors for optical systems.

### BACKGROUND

Making mirrors with highly flat or precisely curved reflective surfaces is typically challenging. When a mirror is checked during production, e.g., in process control or at final quality control, normally no outside forces other than those generated by materials and configuration of the mirror itself affect the shape of the mirror. Today, precision mirrors with a surface accuracy of λ/10 to λ/20 are commonly used in various laser and other precision applications where the optical wave-front needs to be unchanged after reflecting off the mirror. When such mirror is mounted in commonly used kinematic mounts, the mount applies a radial three-point force to hold the mirror in place. Distortion of the mirror surface can occur due to the applied forces on the mirror. Depending on the forces applied and the mirror design, the distortion can be significant and negatively affect optical performance. The problem can get worse in systems where many mirrors are used because this type of distortion tends to additively degrade the optical wave front. One common way to mitigate this issue is to use radial mounting schemes. However, these methods have a number of drawbacks including a higher cost due to increased complexity of the mount; a higher risk of damaging the mirror during the mounting process because they are more complex to use than a standard mount; and increased environmental instability because these mounts use less mounting force to avoid putting stress on the mirror.

### SUMMARY

To overcome the problems described above, embodiments of mirrors disclosed herein are configured to use a mount with a proven 3-point radial engagement. This “Mushroom mirror” is designed in such a way that is does not transfer the radial forces from the mounting surfaces at the back of the mirror to the front mirrored surface. Any forces propagating to the front surface can be close to symmetrical. Symmetrical forces normally result in spherical distortion of the front surface, an error that can be compensated for by using various lenses or curved mirrors in the optical path. Asymmetrical distortion of forces on the front mirrored surface causes a much worse problem because these distortions are almost impossible to correct in other segments of the optical system. Moreover, asymmetrical distortions tend not to be stable over time which result in a poor long term stability of the optical system.

In an embodiment, a mirror includes an optical portion including an optical surface opposite to a rear surface of the optical portion; and a mounting stem protruding from the rear surface of the optical portion and configured to mount to an optical mount.

In the mirror, the optical portion and the mounting stem of the mirror can be of a monolithic body defined from a singular material. Optionally, the optical portion and the mounting stem are coupled to one another.

In the mirror, the optical portion has a first shape, and the mounting stem has a second shape. The first shape and the second shape can be a same shape. The first shape and the second shape can be different shapes. The first shape can be cylindrical, rectangular prism, cubic, conical, or another three-dimensional polygonal shape, and the second shape can be cylindrical, rectangular prism, cubic, conical, or another three-dimensional polygonal shape.

In the mirror, the optical surface is a flat, concave, or convex and can be coated with a metal, dielectric material, or metasurface structure.

In the mirror, the optical portion has a larger dimension than the mounting stem. In the mirror, the mounting stem has a tiered shape having a center stem portion and the mounting portion, the mounting portion being larger than the center stem portion and sized to mount into a mounting portion of the optical mount. In the mirror, the mounting stem can have a tiered shape having a center mounting portion and an outer mounting portion.

In the mirror, the mounting stem can include a threaded portion configured to mate to a threaded mount of the optical mount.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and advantages of the present disclosure will be better understood when read in conjunction with the figures provided. Embodiments are provided in the figures for the purpose of illustrating aspects, and/or features, of the various embodiments, but the claims should not be limited to the precise arrangements, structures, features, aspects, methods, processes, assemblies, systems, or devices shown, and the arrangements, structures, features, aspects, methods, processes, assemblies, systems, and devices shown may be used singularly or in combination with other arrangements, structures, features, aspects, methods, processes, assemblies, systems, and devices.

FIG. 1A is a perspective view of a stemmed mirror according to an embodiment of the present disclosure, and FIG. 1B is a cross-sectional view of the stemmed mirror of FIG. 1A.

FIG. 2A is a perspective view of the stemmed mirror of FIGS. 1A and 1B and an example mirror mount in an unassembled state. FIG. 2B is a perspective view of the stemmed mirror of FIGS. 1A and 1B and the example mirror mount in an assembled state.

FIG. 3A is a graph illustrating cumulative aberrations introduced to a λ/10 stemmed mirror of the current disclosure mounted in the example mirror mount. FIG. 3B is a graph illustrating aberrations introduced to an example λ/10 first surface mirror mounted in the example mirror mount.

FIG. 4A is a phase map of a stemmed mirror mounted by the mirror. FIG. 4B is a phase map of the stemmed mirror mounted by the stem.

FIG. 5A is a perspective view of a stemmed mirror according to another embodiment of the present disclosure, and FIG. 5B is a cross-sectional view of the stemmed mirror of FIG. 5A.

FIG. 6A is a perspective view of a stemmed mirror according to another embodiment of the present disclosure, and FIG. 6B is a cross-sectional view of the stemmed mirror of FIG. 6A.

FIG. 7A is a perspective view of a stemmed mirror according to another embodiment of the present disclosure, and FIG. 7B is a cross-sectional view of the stemmed mirror of FIG. 7A.

FIG. 8A is a perspective view of a stemmed mirror according to another embodiment of the present disclosure, and FIG. 8B is a cross-sectional view of the stemmed mirror of FIG. 8A.

### DETAILED DESCRIPTION

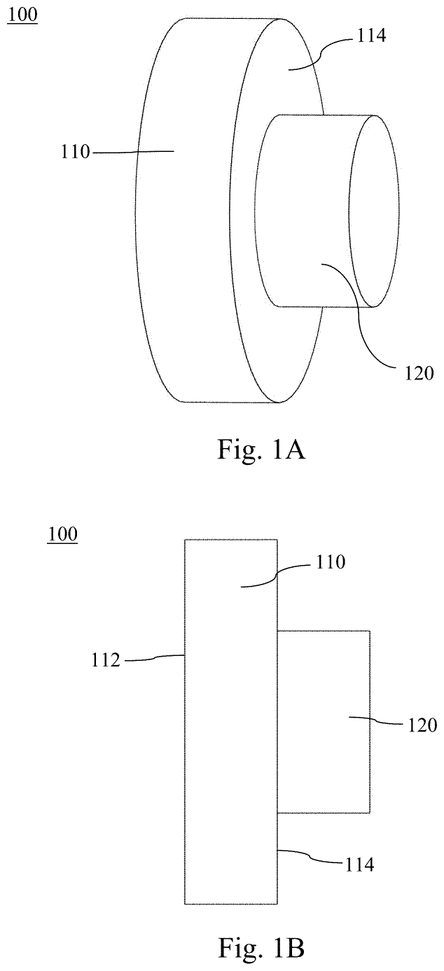

FIGS. 1A and 1B are views of a mirror 100 according to an embodiment of the present disclosure. As shown, the mirror 100 can include an optical portion 110 and a stem 120. The stem 120 can be used for mounting the mirror 100 and be a mounting stem.

Embodiments of the mirror 100 such as that shown in FIGS. 1A and 1B can be either a monolithic piece of glass, crystal, ceramic, or metal or an assembly of any of the following materials: glass, crystal, ceramic, metal, polymer, or composite. Although shown as flat, the mirror surface 112 can flat, concave, or convex. A mirror surface 112 of the mirror 100 can be coated, for example, with a metal or a dielectric material to achieve the optical properties needed. To achieve the desired optical properties, the mirror surface 112 can be finished using traditional optical manufacturing techniques such as polishing, diamond turning, energetic finishing (e.g., Laser, Ion beam, etc., . . . ), or other like techniques. The coating on the mirror surface 112 can be a reflective coating, such as a metallic reflective coating, nanostructured surface, optically resonant structures, or metasurfaces.

If the mirror 100 is designed to transmit a portion of incident light, the back side of the mirror 114 can be polished. The circumference/edges of the mirror 100 can be cut, ground, polished, or blackened using black inks commonly used for optics.

The optical portion 110 of the mirror 100 can have any peripheral shape and is not limited to be circular.

The mirror 100 can be formed in a multitude of various steps to generate a low and symmetrical force that affects the front surface. The step(s) in forming the mirror 100 can be performed using additive or subtractive methods. Subtractive methods include grinding, milling, turning, polishing, or other like of one mass of raw material. These methods create a “monolithic” solution, in which the mirror 100 is made from a single piece of material. For example, the mirror 100 can have a monolithic fused silica construction. Additive solutions include creating individual pieces (e.g., the optical portion 110 of the mirror 100 and the stem 120 of the mirror 100) and coupling the pieces together, for example, but not limited to, by bonding the pieces together. In one or more cases, the individual pieces can be created using 3D printing options. In some cases, the optical portion 110 and the stem 120 can be made of different materials. For example, the optical portion 110 can be made of glass, sapphire, or other like materials, and the stem 120 can be made of a material that can be thermal expansion matched to the material that is being used for the optical portion 110. Optionally, a layer of elastomeric material can be provided between the optical portion 110 and the stem 120 to reduce any stress transfer between the stem 120 to the optical portion 110 when the mirror 100 is mounted by the stem 120.

Mirrors of the current embodiments can be used in applications that need a surface accuracy higher than λ/4 (P-V) at a required wavelength. A mirror according to an embodiment has a front surface accuracy better than λ/10 when unmounted.

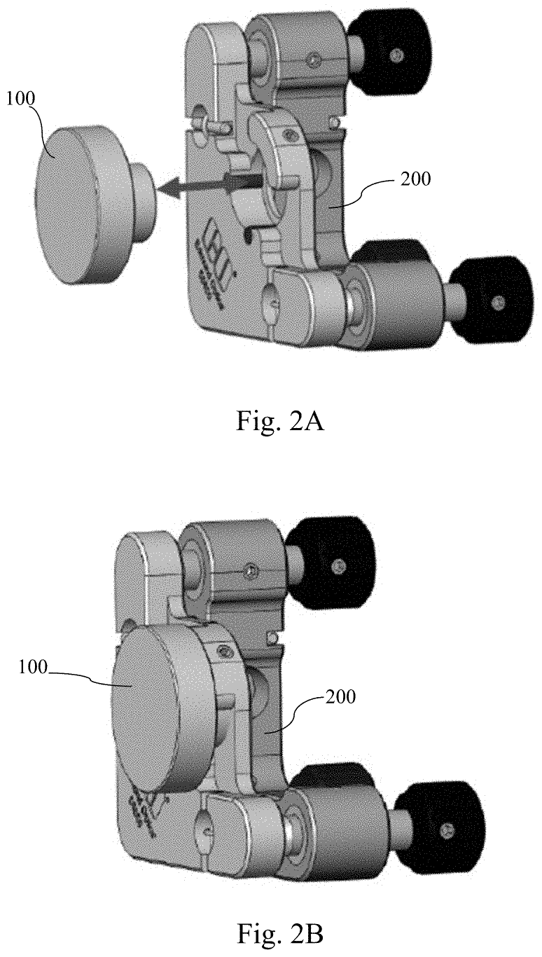

The stem 120 is designed to reduce stress on the optical portion 100 and the front surface 112 when secured to an optical mount, such as a kinematic mount. All contact between the mirror 100 and the kinematic mount is through the stem 120, reducing the stress transferred to the optical portion 100 and front surface 112 of the mirror 100. That is, the mirror 100 can be mounted to the kinematic mount via the stem 120 at the rear surface of the optical portion 110, resulting in the kinematic mount holding the mirror 100 without contacting the edges of the optical portion 110. This is shown in FIGS. 2A and 2B. Transfer of the stress between the stem 120 and the optical portion 110 caused by the forces needed to mount the mirror 100 can be minimized or eliminated The kinematic mount 200 hold the stem of the mirror 100 at, for example, three points of contact.

For example, the mirror 100 of FIGS. 2A and 2B features a monolithic design and is made from fused silica. The mirror 100 can include a metallic coating, including enhanced aluminum, protected gold, protected silver, and other like coatings.

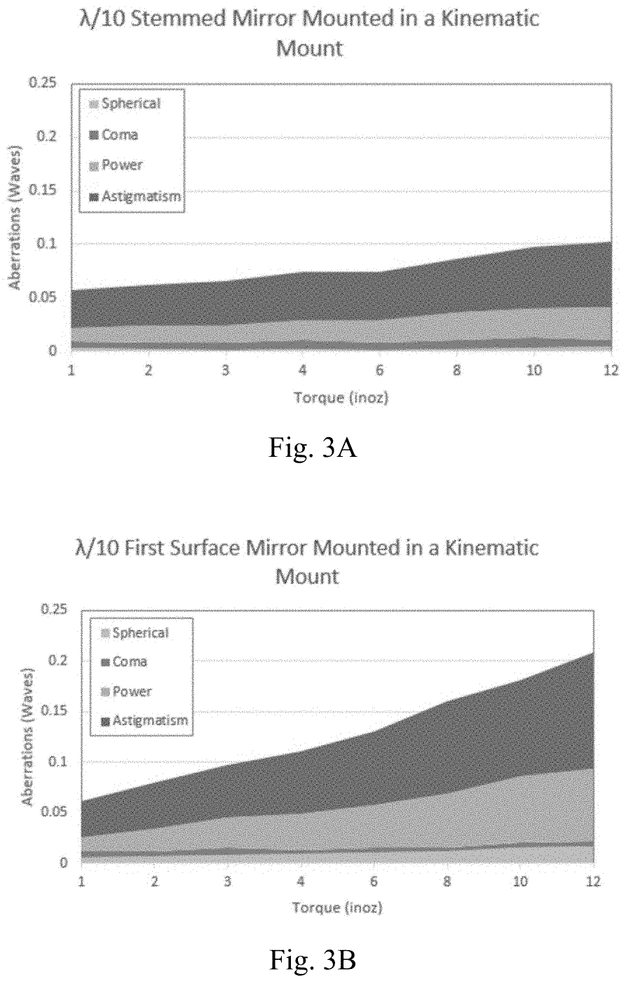

The mirror 100 can have a higher surface accuracy when mounted, than conventional λ/10 mirrors directly mounted into kinematic mounts due to its stress-reducing design. The graph in FIG. 3A plotting mounting torque (in-oz) verus optical abberations shows that the mirror 100 maintains performance within λ/10 up to 12 in-oz of torque (“hand-tight”) provided to the stem 120 while in the mount. FIG. 3B shows that a conventional first surface mirror mounted by its periphery becomes out of specification with a surface accuracy of λ/5 under the same mounting conditions.

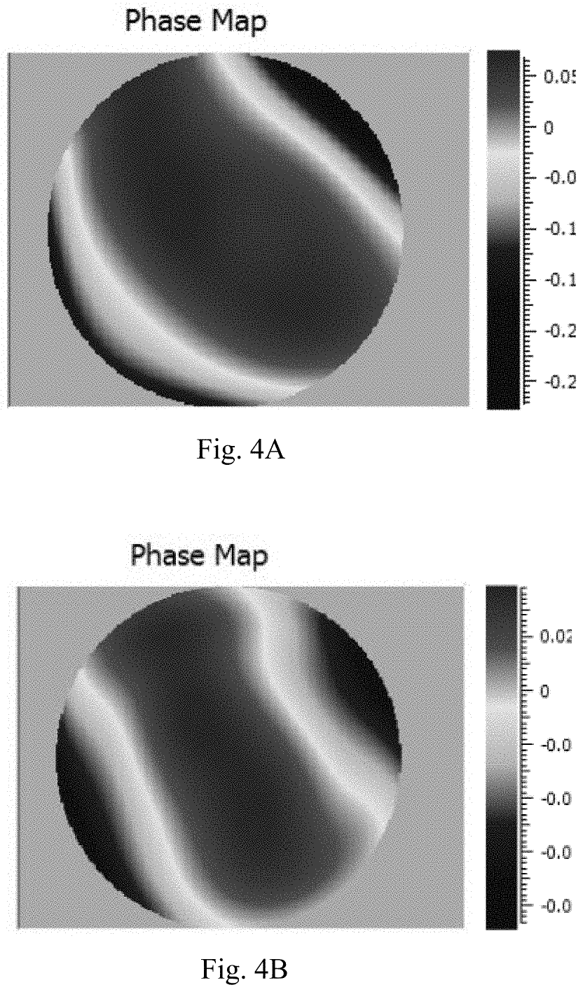

FIGS. 4A and 4B are phase maps of the same 1″ diameter mirror with a 0.5″ diameter step taken with an interferometer at 632.8 nm. The data of FIG. 4A was taken on the stemmed mirror while being retained in a kinematic mount by the edges of the mirror. The data of FIG. 4B was taken on the stemmed mirror while being retained in a kinematic mount by the stem. As shown, the phase errors are less when the mirror is retained in the mount by the stem. When data was taken for FIG. 4A, the peak-to-valley (PV) error was 0.3420 wv and the RMS error was 0.0661 wv. When data was taken for FIG. 4B, the peak-to-valley (PV) error was 0.1249 wv and the RMS error was 0.0307 wv, a significant reduction in phase error compared to when the stemmed mirror was being retained in a kinematic mount by the edges of the mirror. The Seidel Aberration data was also reduced.

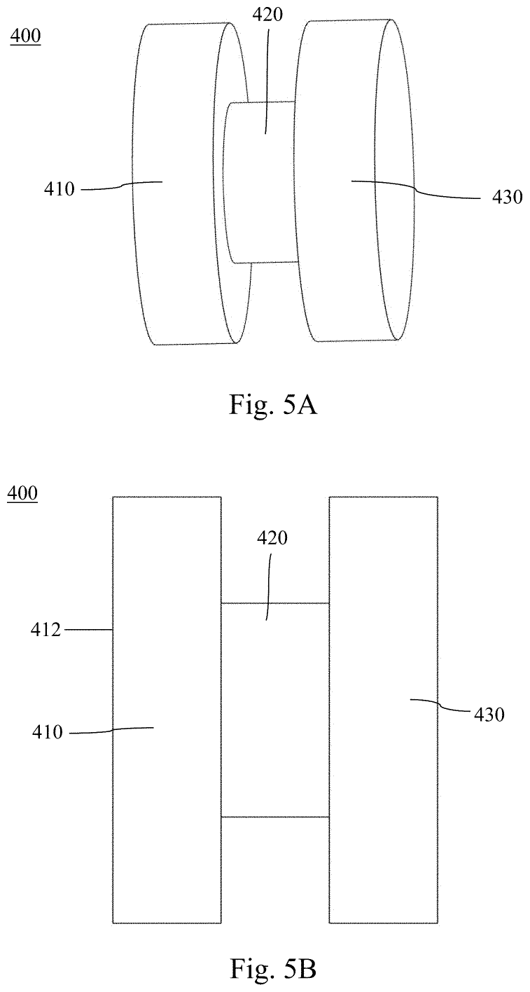

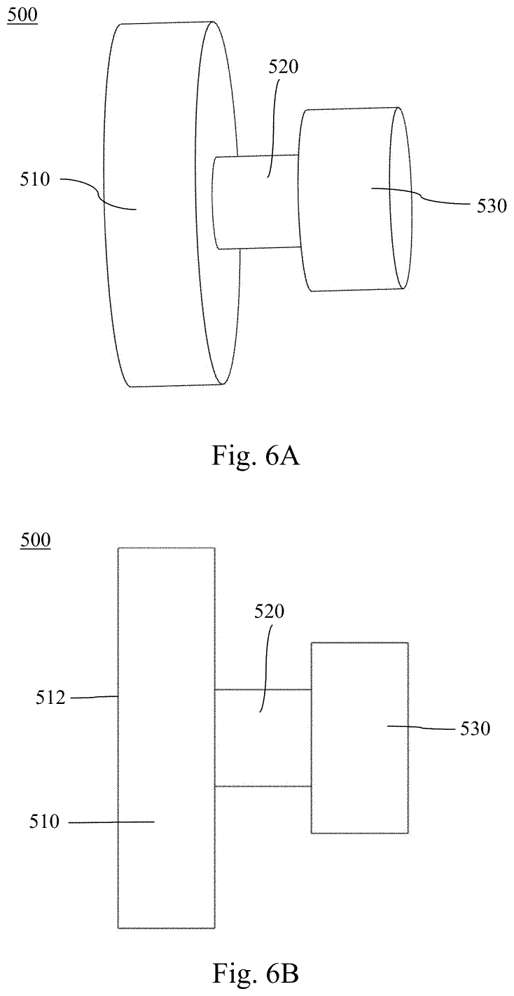

Other embodiments of mirrors can be designed and constructed using multiple steps to reduce the transfer of the stress from the kinematic mount. For example, FIGS. 5A, 5B, 6A, and 6B show mirror configurations 400 and 500, respectively, with two end portions 410 and 430, 510 and 530 on opposite sides of a center portion 420, 520. One of the two end portions 410 and 430, 510 and 530, for example 410 and 510, can be the optical portion with the outer surface 412, 512 manufactured as a mirror. The center portion 420, 520 and one of the two end portions 410, 430, 510, 530, for example 430 and 530, can be used to mount the mirrors 400 and 500 and effectively serve as the stemmed portion of the mirrors 400 and 500. A larger stemmed portion opposite to the optical portion can be mounted into larger kinematic mounts.

In an embodiment, the stemmed portion can be the same size as the optical portion, as in FIGS. 5A and 5B. Optionally, the stemmed portion can be larger than the optical portion. Conversely, as shown in FIGS. 6A and 6B, the mirror 500 can have a stemmed portion that includes the center portion 520 and the rightmost end 530, which is relatively smaller than the optical portion 510 and larger than the center portion 520. This configuration allows the mirror 500 to be mounted into smaller optical mounts. In addition, embodiments such as this allow reduced diffraction, because it is common for standard mounts to include a forward stop which is placed in front of the optical surface and either completely or partially blocks the edge of the mirror. Furthermore, this reduces cost for the mounting system, as the size of the kinematic system for aligning the optical surface to the rest of the system is significantly smaller.

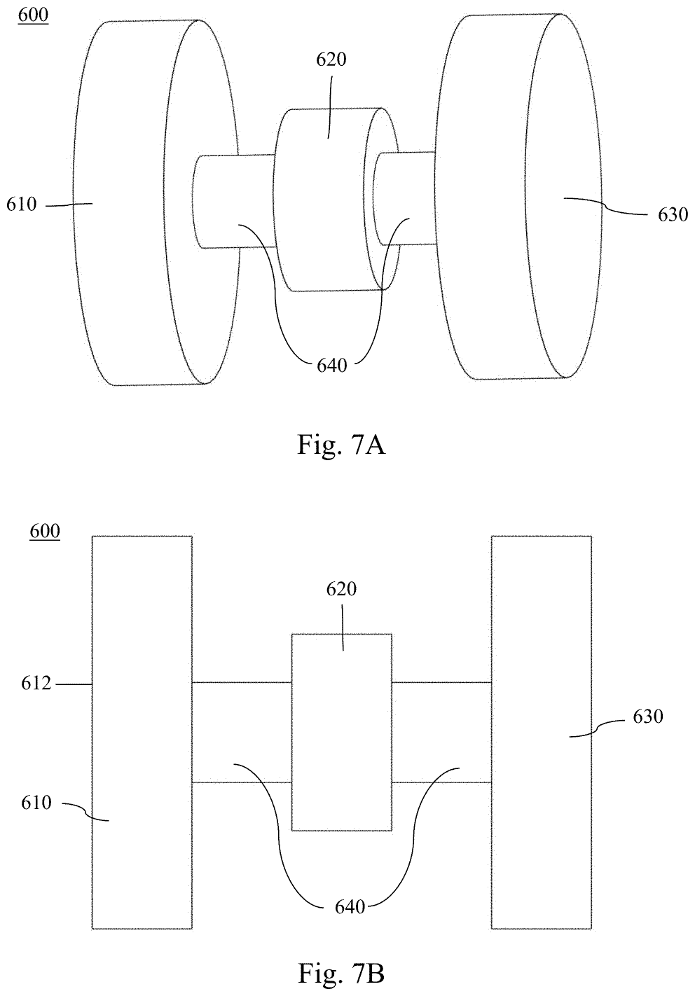

In another embodiment, as shown in FIGS. 7A and 7B, the mirror 600 can be configured with portions having various sizes to accommodate different sized optical mounts. For instance, a center portion 620 can be joined to an optical portion 610 including a mirror surface 612 and an outer portion 630 with connecting portions 640. The center portion 620 can be used to mount the mirror 600 to a kinematic mount having a smaller mounting area, and the outer portion 630 can be used to mount the mirror 600 to a kinematic mount having a larger mounting area.

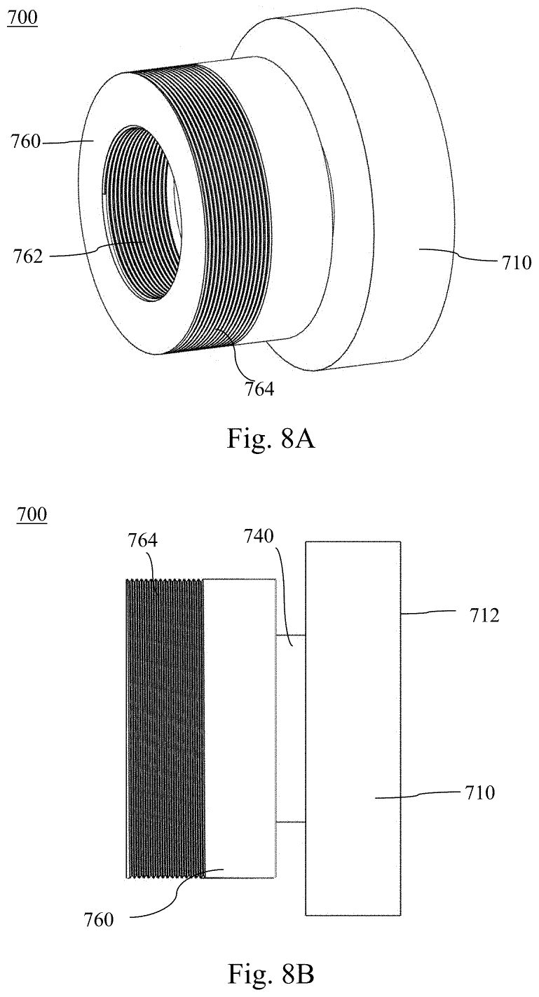

In an embodiment shown in FIGS. 8A and 8B, the stem (not visible) of the mirror 700 can be bonded to a metal ring 760. The metal ring 760 can be configured to fit over the stem and include features used to interface with other styles of mounts different than a kinematic mount. For example, as shown, the metal ring 760 can include interior threads 762 and/or exterior threads 764 used for mounting. Optionally, the metal ring 760 can include any suitable features such as pins and grooves of a bayonet mount for mounting. Optionally, an elastomer can be located between the metal ring 760 and the mirror base. Optionally, the stem can be joined to an optical portion 710 that includes a mirror surface 712 via a connecting portion 740.

It is noted that that portions shown or described herein are illustrated as being cylindrical, but it should be understood that these portions can be defined in a variety of shapes, such as a rectangular prism, a cube, a cone, or any other suitable three-dimensional polygonal shape. Further, the embodiments of the mirrors described herein can be defined with monolithic construction or as individual pieces coupled together, as previously described.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. A mirror comprising:
an optical portion including an optical surface opposite to a rear surface of the optical portion; and
a mounting stem protruding from the rear surface of the optical portion and configured to mount to an optical mount.

2. The mirror of claim 1, wherein the optical portion and the mounting stem are of a monolithic body defined from a singular material.

3. The mirror of claim 1, wherein the optical portion and the mounting stem are coupled to one another.

4. The mirror of claim 1, wherein the optical portion has a first shape, and the mounting stem has a second shape.

5. The mirror of claim 4, wherein the first shape and the second shape are a same shape.

6. The mirror of claim 4, wherein the first shape and the second shape are different shapes.

7. The mirror of claim 4, wherein
the first shape is cylindrical, rectangular prism, cubic, conical, or another three-dimensional polygonal shape, and
the second shape is cylindrical, rectangular prism, cubic, conical, or another three-dimensional polygonal shape.

8. The mirror of claim 1, wherein the optical surface is a flat, concave or convex surface.

9. The mirror of claim 1, wherein the optical surface is coated with a metal or dielectric material.

10. The mirror of claim 1, wherein the optical portion has a larger dimension than the mounting stem.

11. The mirror of claim 1, wherein the mounting stem has a tiered shape having a center stem portion and the mounting portion, the mounting portion being larger than the center stem portion and sized to mount into a mounting portion of the optical mount.

12. The mirror of claim 1, wherein the mounting stem has a tiered shape having a center mounting portion and an outer mounting portion.

13. The mirror of claim 1, wherein the mounting stem includes a threaded portion configured to mate to a threaded mount of the optical mount.
